(19) United States
(12) Patent Application Publication
(10) Pub. No.: US 2022/0061553 A1
(43) Pub. Date: Mar. 3, 2022

(54) PORTABLE TECHNOLOGY COMPANION KIT

(71) Applicant: Tiffany Louise McCoy, Woodridge, IL (US)

(72) Inventor: Tiffany Louise McCoy, Woodridge, IL (US)

(21) Appl. No.: 17/410,277

(22) Filed: Aug. 24, 2021

Related U.S. Application Data
(60) Provisional application No. 63/069,958, filed on Aug. 25, 2020.

(51) Int. Cl. A47D 15/00; B60R 11/02; B60N 2/28

(52) U.S. Cl. CPC A47D 15/00; B60R 2011/0012; B60N 2/2866; B60R 11/02

(57) ABSTRACT

A portable companion technology kit for use in with a child seat is provided which includes a holder for a smart device which may be attached to a flexible support art which may be mounted to the seat portion of a child seat to allow for hands free and secure use of the smart device. As part of the kit, a rechargeable battery power pack with the necessary connections and USB ports is included and may be mounted on the bottom, side or back of a child seat for recharging the smart device. Such devices may be used with children with disabilities, attention disorders, sensory disorders, etc. where use of such devices assist in calming a child suffering from a disability.

### CROSS-REFERENCE TO RELATED APPLICATION

This application claims the benefit of U.S. Provisional Application No. 63/069,958 filed Aug. 25, 2020 and hereby incorporates the entire disclosure of that application by reference.

None.

### FEDERALLY SPONSORED RESEARCH OR DEVELOPMENT

Not Applicable.

### BACKGROUND THE INVENTION

In today's society, young children are exposed to a variety of portable electronic devices, including portable smart devices such as cellular phones, Ipads, Surface pads and tablets. Such devices are relied upon by adults to entertain young children when they are sitting for various amounts of time in car seats, booster seats, strollers, swings and highchairs. Such devices may also be used with children with disabilities, attention disorders, sensory disorders, etc. where use of such devices assist in calming a child suffering from a disability. The ability to simply mount such devices so that they are essentially hands free and secure during use and also safe from being damaged has proven to be a challenge. Indeed, what is lacking in the market is a simple and affordable means for mounting, charging and adjusting the placement of electronic devices on the various child seats mentioned above.

The present invention offers a solution to the foregoing problems by providing a kit for mounting a smart device to a car seat, booster seat, stroller, swing or highchair which includes a holder for smart device which can be mounted on a flexible support arm assembly which can be mounted on a seat portion of a car seat, booster seat, stroller, swing or highchair (collectively “child seat”) using at least one set of base feet. In addition, a rechargeable battery power pack with the necessary connections and USB ports is included and may be mounted on the bottom, side or back of the child seat for recharging the smart device.

### SUMMARY OF THE INVENTION

The present invention relates generally to a kit for use with a child seat and provides a holder for a smart device which is attached to a flexible support arm assembly which may be mounted to the seat portion of a child seat by use of at least one pair of adjustable base feet, namely an upper foot and bottom foot, to allow for hands free and secure use of the smart device. As part of the kit, a rechargeable battery power pack with the necessary connections and USB ports is included and may be mounted on the bottom, side or back of the child seat for recharging the smart device.

### BRIEF DESCRIPTION OF THE DRAWING

FIG. 1 is a front view of one embodiment of the portable companion technology kit of the present invention mounted to a representative child seat, namely a child booster seat.

FIG. 2 is a front view of the seat portion of a child booster seat with a seat cover.

FIG. 3 is a partial view of the bottom side of a child booster seat in which a portion of the bottom side has been removed to provide an opening for placement of the bottom foot of the pair of adjustable feet to attach the flexible arm assembly to the child booster seat.

FIG. 4 is a side view of the flexible arm assembly which can be attached to the child booster seat.

FIG. 5a is a partial front view of the upper portion of the flexible arm assembly with the smart device attached; FIG. 5b is a rear view of the smart device holder.

FIG. 6 is a partial view of the bottom side of a child booster seat where the flexible support arm assembly is attached to the booster seat by inserting the lower foot of the pair of base feet into the opening created in the bottom section and adjusting and aligning the upper base foot situated on the exterior side of the child booster seat with the lower base foot to sandwich the side of the child booster seat between the base feet.

FIG. 7 is a side view of the fully assembled kit in which the flexible support arm assembly, the smart device holder and the child booster seat are attached, and a smart device may be inserted into the smart device holder.

FIG. 8 is another side view of the fully assembled kit in which the flexible support arm assembly, the smart device holder and the child booster seat are attached, and a smart device may be inserted into the smart device holder.

### DETAILED DESCRIPTION OF THE PREFERRED EMBODIMENT

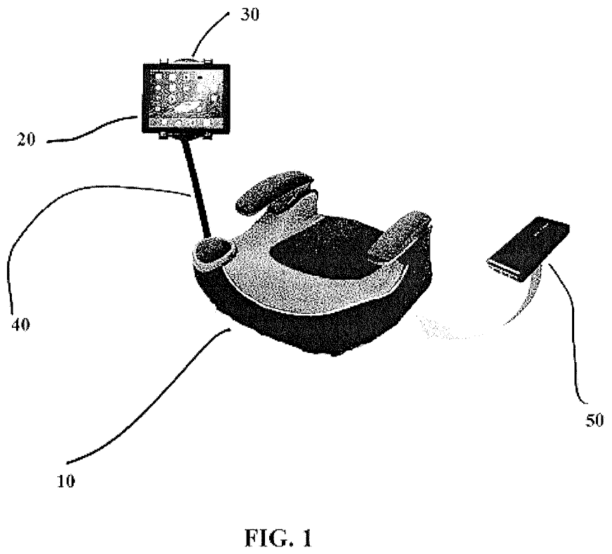

The portable companion technology kit of the present invention is explained with reference to FIG. 1. For illustration purposes only, a typical child booster seat 10 and a smart device 20 are provided with the elements of the technology kit. As shown in FIG. 1, a holder 30 for a smart device is provided which may actually be adjustable to hold different sized smart devices. A flexible support arm assembly 40 is provided, the lower part which can be mounted on the seat portion of booster seat 10 using at least one pair of base feet of the flexible arm assembly with the side portion of the seat being sandwiched between the upper base foot and the lower base foot. The holder 30 is mounted on the top portion of the flexible support arm assembly 30 so that smart device 20 are may be mounted on the flexible arm assembly.

In addition, a rechargeable battery power pack 50 with the necessary connections and USB ports is included for recharging smart device 20 and may be mounted in a pocket or on the bottom, side or back of the booster seat 10. The means for mounting may include hook and loop fasteners which may be attached to the respective surfaces for attachment.

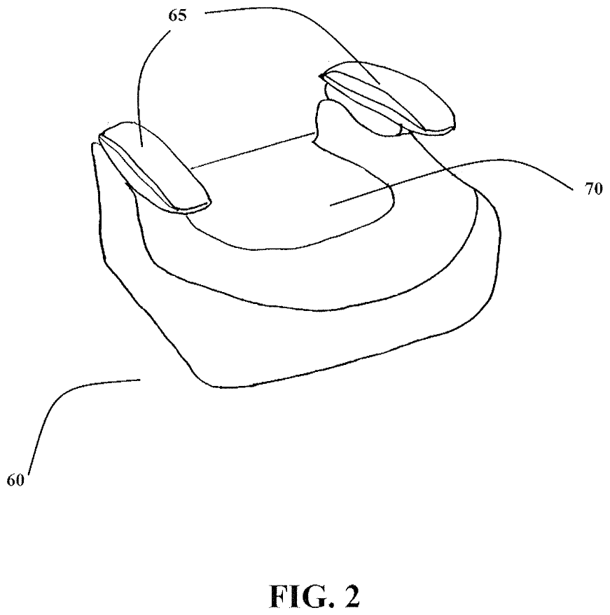

An exemplary child booster seat 60 is shown in FIG. 2. The typical child booster seat is made from a tough plastic, such as polypropylene, that flexes under pressure. The child booster seat 60 is usually molded plastic with an empty interior and has molded arm rests 65 on each side of the seat. The child booster seat also has a padded seat cover 70 which is fitted to the seat and extends under the bottom of the seat to stay in place.

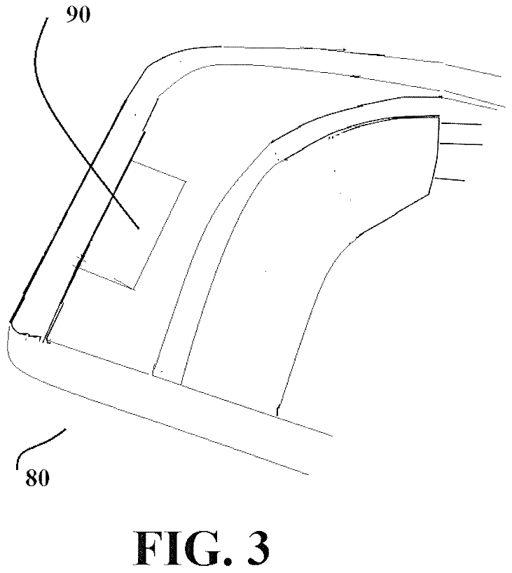

To use the flexible support arm assembly 40 with a child booster seat, an opening must be made on the bottom side of the booster seat 60 to accept and hold the lower foot of the support arm assembly. A partial view of the bottom side 80 of booster seat 60 is shown in FIG. 3. In order to hold and accept the lower foot of the support arm assembly, an opening 90 must be cut in the bottom of the child booster seat. The opening must be long enough and wide enough to allow the lower foot of the support arm assembly to be inserted into it easily.

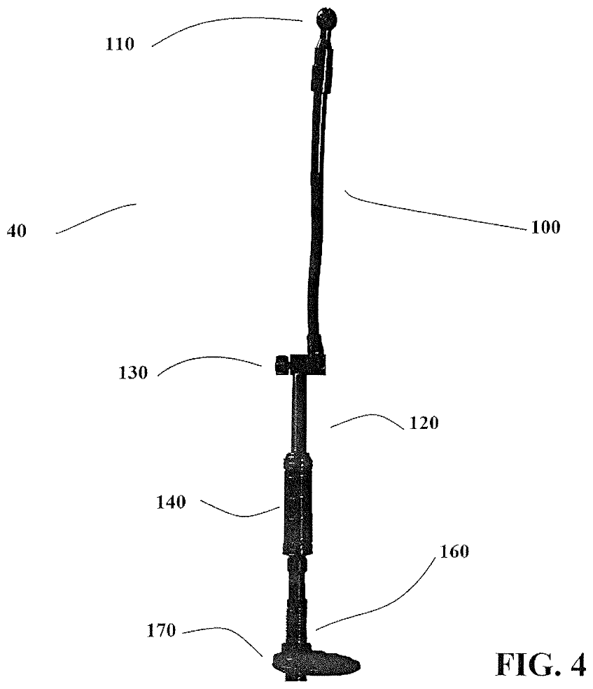

The flexible support arm assembly 40 is shown in FIG. 4. The upper arm portion 100 of the assembly is manufactured with a flexible core wrapped in TPE plastic and is the bendable portion of the assembly. At the top of the upper arm portion is a rounded tip 110 made of ABS plastic for attaching the smart device holder 30 to the flexible support arm assembly. The upper arm portion 100 is attached to the lower portion 120 of the flexible support arm assembly by means of a rotational hinge mechanism 130 assembly. The rotational hinge mechanism 130 is manufactured from ABS plastic and incudes integrated teeth and a thumb screw assembly for adjustment options to tighten and loosen the hinge mechanism. By means of the rotational hinge mechanism, the flexible support arm assembly 40 may be adjusted so that the upper arm portion 100 can be adjusted at various angles to the lower portion 120.

The lower portion of the flexible support arm assembly also includes a retention ring 140 made out of ABS plastic and is integrated to insure a tight fit when threaded into place on the lower portion and provides for 360 degrees of rotation of the entire flexible support arm assembly. A threaded cover component 150 is provided on the lower portion which is also made of ABS plastic and threads over the retention ring 140 to enclose the ring and protect against pinch points when used. Secured by retention ring 140 to the lower portion of the flexible support arm assembly is a rigid aluminum support 160 that is threaded to allow upper base foot 170 to be adjusted to secure the child seat between the upper base foot 170 and lower base foot 180. Both base feet are made from ABS plastic and each include rubber padding to aid in securing the flexible support arm assembly to the child seat.

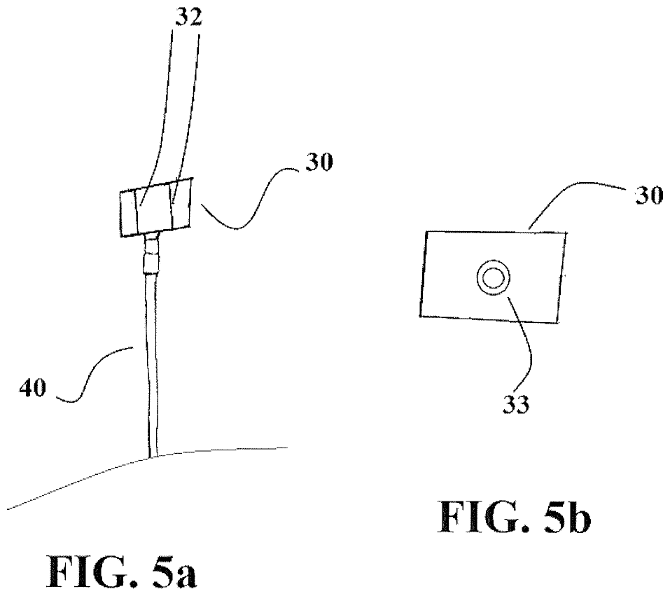

FIG. 5a shows a partial front view of the upper portion of flexible support arm assembly 40 with the smart device holder 30 attached. The smart device holder 30 has slides 32 which can be adjusted to fit different size smart devices. If a mobile phone is used, the slides may be adjusted inward; if a tablet is used, the slides may be adjusted outwardly. FIG. 5b shows a rear view of the smart device holder 30 where a circular half sphere projection 33 is provided to attach the smart device holder to the tip portion of the upper portion of the flexible arm support assembly.

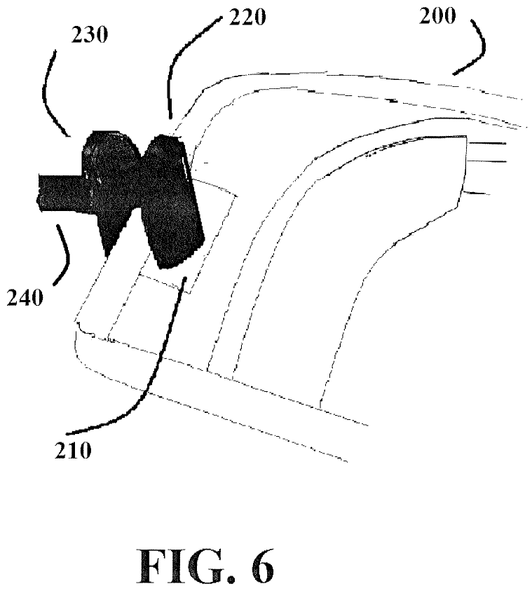

A partial view of the attachment of the flexible support arm assembly to the bottom of a child booster seat is shown in FIG. 6. The partial view shows bottom portion 200 of the child booster seat in which an opening 210 has been provided to accept and hold the bottom foot 220. The upper foot 230 is adjusted along the threaded portion of aluminum support arm 240 to obtain a tight fit with the child booster seat.

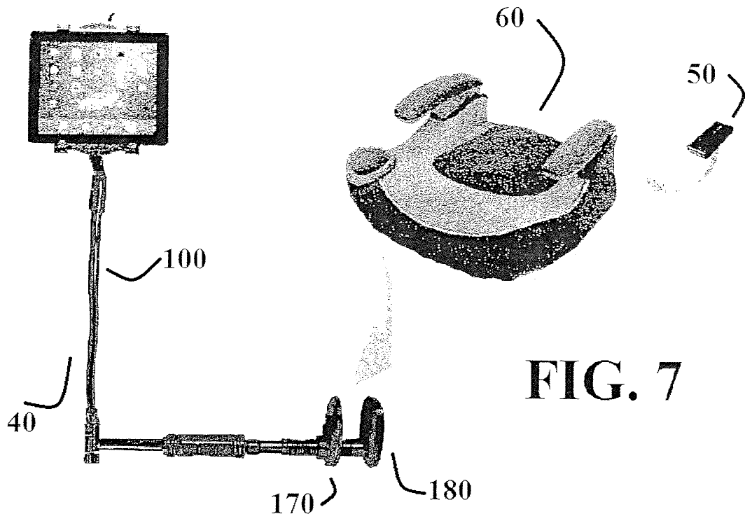

Once the flexible support arm assembly is securely attached to the child booster seat, the child booster seat is returned to its normal position and the flexible arm support assembly with the smart device holder attached is adjusted so that the flexible upper portion holds the smart device so that it is visible to the child sitting in the child booster seat. A side view of how that configuration is assembled is shown in FIG. 7. The flexible arm assembly 40 is folded at the rotational hinge mechanism 130 so that the lower portion of the flexible arm assembly lies flat with the base feet extending upwardly. The side portion of car booster seat 60, where the opening has been provided, is placed between the upper base foot 170 and the base feet 170 and 180 are adjusted so that the side of the child booster seat is firmly sandwiched between the base feet. For additional stability, lower base foot 180 may be attached to the child booster seat using two hex stainless-steel screws.

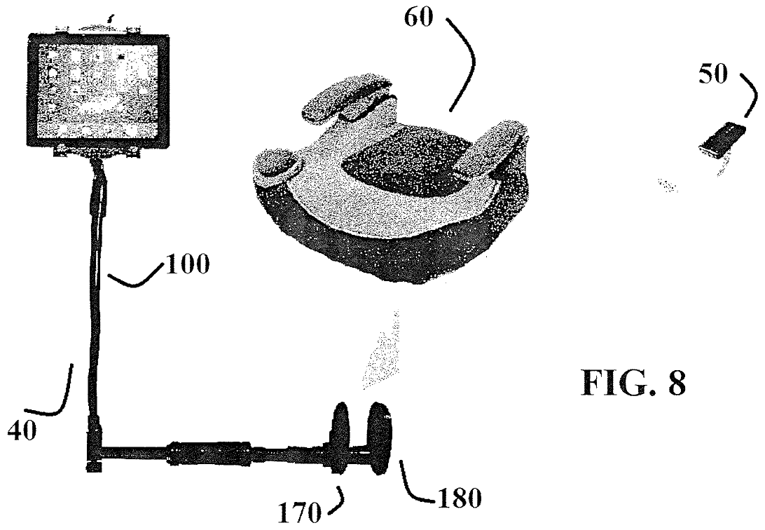

Alternatively, the opening 90 in the child booster seat shown in FIG. 3 may be made on the opposite side of the seat. When assembling the configuration, as shown in FIG. 8, the flexible arm assembly 40 is folded at the rotational hinge mechanism 130 so that the lower portion of the flexible arm assembly lies flat with the base feet extending upwardly. The car booster seat 60 is positioned over the lower portion of the flexible arm assembly so that the opening on the bottom of child booster seat 60 is aligned with upper base foot 170 for insertion into the opening and lower base foot 180 is positioned on the exterior side of the child seat. Base feet 170 and 180 are adjusted so that the side of the child booster seat is firmly sandwiched between the base feet. As set forth above, for additional stability, lower base foot 180 may be attached to the child booster seat using two hex stainless-steel screws.

Additionally, a rechargeable battery power pack 50 with the necessary connections and USB ports is included for recharging smart device 20 and may be mounted on the bottom, side or back of the booster seat by hook and loop fasteners attached to the respective surfaces of the battery pack and bottom of the booster seat.

The previous description is one exemplary embodiment for implementing the invention and the scope of the invention should not be limited by this description.

What is claimed is:

1. A portable technology companion kit for use with a child seat comprising:
a child seat made of polypropylene,
a portable smart device,
a flexible arm support assembly having a holder for the smart device removably attached at the top, a rotational hinge mechanism for folding the flexible arm support assembly at various angles and upper and lower base feet for attaching the flexible arm support assembly to the child seat,
wherein the kit includes a child seat with an opening in the bottom near the one of the sides of the seat;
the flexible arm support assembly is folded at the rotational hinge mechanism and locked in place;
the portable smart device is attached to the smart device holder;
the opening made in the bottom of the child seat is aligned with the base feet of the flexible arm support assembly with the lower base foot inserted into the opening and the upper base foot positioned on the exterior side wall of the child seat with the base feet adjustable in the flexible arm assembly to sandwich the side wall of the child seat between the upper base foot and lower base foot; and
a rechargeable power pack with USB ports for recharging smart device 20 is mounted in a pocket or on the bottom, side or back of the child seat;
wherein, the kit assembly provides the occupant of the child seat with access to a smart device held by the flexible arm which can be adjusted to various viewing levels by movement of the flexible arm support assembly and allows for hands-free use by the occupant.

2. A portable technology companion kit for use with a child seat comprising:
a child seat made of polypropylene,
a portable smart device,
a flexible arm support assembly having a holder for the smart device removably attached at the top, a rotational hinge mechanism for folding the flexible arm support assembly at various angles and upper and lower base feet for attaching the flexible arm support assembly to the child seat,
wherein the kit includes a child seat with an opening in the bottom near the one of the sides of the seat;
the flexible arm support assembly is folded at the rotational hinge mechanism and locked in place;
the portable smart device is attached to the smart device holder;
the opening made in the bottom of the child seat is aligned with the base feet of the flexible arm support assembly with the upper base foot inserted into the opening and the lower base foot positioned on the exterior side wall of the child seat with the base feet adjustable in the flexible arm assembly to sandwich the side wall of the child seat between the lower base foot and upper base foot;
a rechargeable power pack with USB ports for recharging smart device 20 which may be mounted in a pocket or on the bottom, side or back of the child seat; and
a rechargeable power pack with USB ports for recharging smart device 20 which may be mounted in a pocket or on the bottom, side or back of the child seat;
wherein, the kit assembly provides the occupant of the child seat with access to a smart device held by the flexible arm which can be adjusted to various viewing levels by movement of the flexible arm support assembly and allows for hands-free use by the occupant.
